(19) United States
(12) Patent Application Publication
(10) Pub. No.: US 2007/0009153 A1
(43) Pub. Date: Jan. 11, 2007

(54) Segmentation of digital images

(75) Inventors: William F. Gallafent, Bedfordshire (GB); Timothy Milward, Oxford (GB)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Bourbay Limited, London (GB)

(21) Appl. No.: 11/442,068

(22) Filed: May 26, 2006

(30) Foreign Application Priority Data
May 26, 2005 (GB) GB 0510793.3

(51) Int. Cl. G06K 9/34

(52) U.S. Cl. 382/173

(57) ABSTRACT

A method and system for segmenting a digital image is presented allowing manipulation of an image, for example by extracting a foreground portion of the image and overlaying the extracted foreground onto a new background. The invention provides an automated process requiring only a single user selection of an area of an image from which two or more image segments are automatically derived. The image segments typically include foreground, background and mixed portions of the image. In this way the invention allows a single selection within one of the foreground or background portions of the image to be made to define foreground, background and edge image segments. The process uses a technique of expanding a selected area, determining a complementary region and eroding then expanding the complementary region so as to derive the desired image segments. An image mask based on the image segments may be generated by assigning opacity values to each pixel allowing blending calculations to be applied to mixed pixels.

### REFERENCE TO RELATED APPLICATIONS

The present application claims priority to British Patent Application Serial No. GB 0510793.3 entitled “Segmentation of Digital Images,” filed on May 26, 2005, which is herein incorporated by reference.

### FIELD OF THE INVENTION

This invention relates to digital image processing, and in particular to the process of segmenting digital images in which an image is separated into regions so that, for example, a foreground region may be separated from a background region.

### BACKGROUND OF THE INVENTION

In publishing and graphic design work-flows, there are many repetitive and tedious components. Reducing the skill and time requirements of any of these components is desirable due to the consequent reductions in cost and tedium conferred upon the organisation and individual in question performing the image processing tasks.

For example, the task of generating modified versions of an image containing the subject of the original image only, with the original background masked out (rendered transparent), for the purpose of overlaying that subject on to a new background image, often takes a large proportion of the overall time spent preparing graphical documents. The portion of the image that is masked out may be defined by an opacity mask. Further processing may be performed on digital images modified using this kind of technique. For example, some images may comprise ‘mixed’ pixels whose visual characteristics are defined by contributions from one or more objects, such as a foreground object and background. In this case an image may be modified to eliminate colour pollution due to colour contributions from the original background in mixed pixels so that the modified image consists of pixels having colour contributions arising from the subject only.

After an opacity mask has been defined, some subsequent image processing steps may be carried out automatically.

One common class of tasks of this nature involves the extraction of a complex foreground object from a relatively uniform background. Despite the apparent simplicity of this task, it still occupies a significant amount of time for each image.

At present, masking tools require a significant amount of input before enough information is present for the automated processing steps to take place. For example, when using tools which require the user to specify samples of the foreground and background in order to separate the foreground from the background, often relatively complete selections of foreground and background are required, or the user is required to paint around the entire boundary of the subject.

We have appreciated that it is therefore desirable to provide a system and method which minimises the amount of work required, for example to extract the subject of a digital image from its background, and which minimises the number of user operations required. We have further appreciated that it is desirable to provide a system and method which automatically performs some or all of the remaining processing, for example, to generate an opacity mask and the modified foreground image (for example, in which background colour pollution is eliminated) for subsequent compositing.

### SUMMARY OF THE INVENTION

The invention is defined in the appended claim to which reference may now be directed. Preferred features are set out in the dependent claims.

In broad terms the invention resides in an automated process requiring only a single user selection of an area of an image from which two or more image segments are automatically derived. The image segments typically include foreground, background or mixed portions of the image. In this way the invention allows a single selection within one of the foreground or background portions of the image to be made to define both foreground and background image segments. The process uses a technique of expanding a selected area, determining a complementary region and eroding and expanding the complementary region so as to derive the desired image segments.

### BRIEF DESCRIPTION OF THE FIGURES

FIG. 1 shows an image comprising a foreground region and a background region;

FIG. 2 shows a selection of pixels of the image shown in FIG. 1;

FIG. 3 shows an expanded pixel selection derived from the pixel selection shown in FIG. 2;

FIG. 4 shows a pixel selection comprising those pixels not in the pixel selection shown in FIG. 3;

FIG. 5 shows a pixel selection derived by eroding the pixel selection shown in FIG. 4 a set number of times;

FIG. 6 shows an expanded pixel selection derived from the pixel selection shown in FIG. 5;

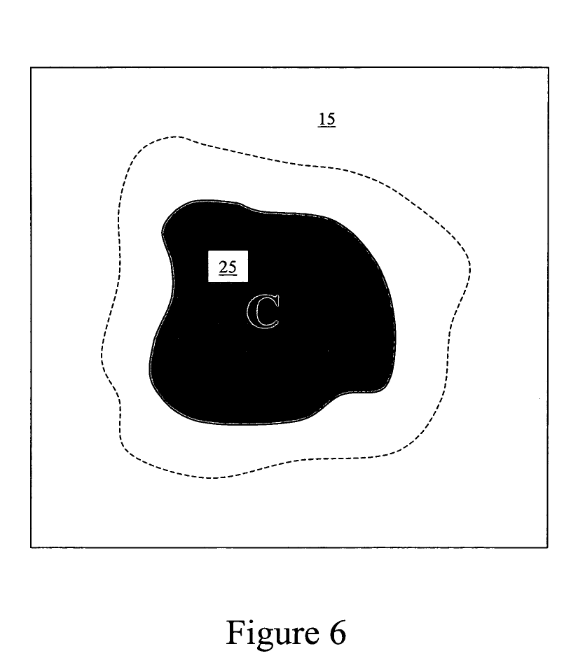

FIG. 7 shows the image of FIG. 1 segmented using the invention;

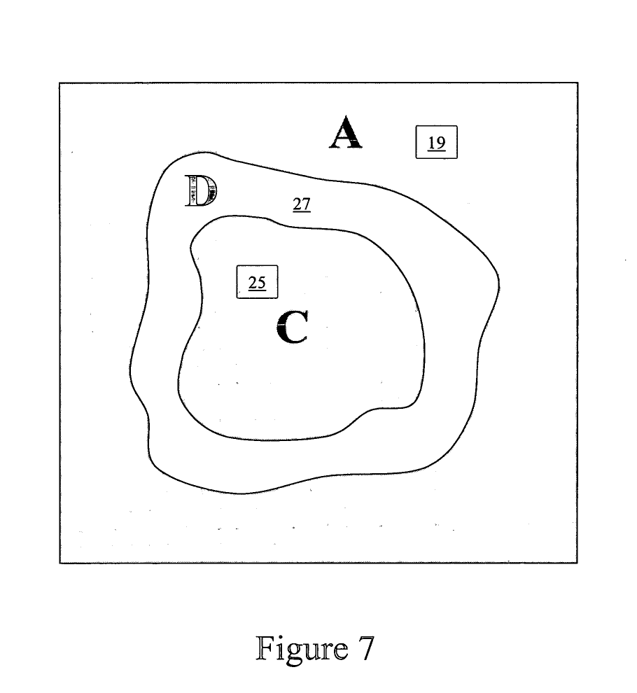

FIG. 8 shows a flow chart of a method according to the invention; and

FIG. 9 is a schematic diagram of a system arranged to carry out the method of FIG. 8.

### DESCRIPTION OF PREFERRED EMBODIMENTS OF THE INVENTION

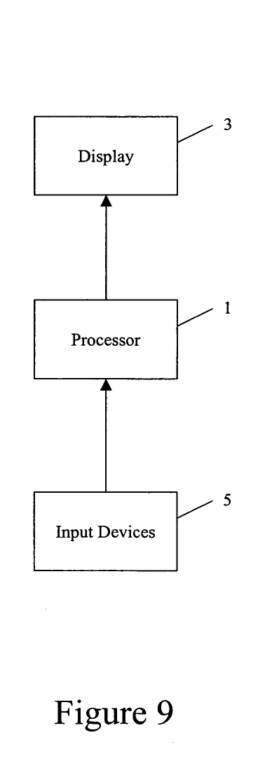

The present invention may be implemented on any suitable computer system, such as the one illustrated schematically in FIG. 9, comprising a processor 1 for performing various digital image processing steps, a display 3 such as a monitor for displaying digital images and a user interface, and input devices 5 such as a keyboard and mouse to allow the user to control the user interface, make selections and input data.

The present invention may be used to manipulate digital images, for example by extracting a foreground portion of an image and overlaying the extracted foreground onto a new background. In order to achieve this, the image is first segmented to define various image segments, each image segment comprising a set of pixels which form the various portions of the image. For example, a foreground image segment may be defined comprising pixels which form the foreground portion of the image and a background image segment may be defined comprising pixels which form the background portion of the image. It is often useful to define an edge or boundary image segment comprising pixels on an edge or boundary region between the foreground and background portions of the image where blending or mixing of the foreground and background can occur. In this way, when the foreground is extracted and overlaid onto a new background, blending calculations may be applied to the mixed pixels to remove the effects of the old background and re-blend according to the new background. Examples of making such a segmentation are described in our International patent application number PCT/GB2005/000798, incorporated herein by reference.

In some techniques, an image segmentation is performed by first performing a segmentation of the abstract space representing all possible ranges of visual characteristics (for example colour and texture) of a pixel. Such a space may be referred to conveniently as ‘visual characteristic space’ or VC space for short. The visual characteristic of a pixel may be defined by one or more parameters and the VC space is defined so that each point in the VC space represents a different visual characteristic, the co-ordinates of a point being the parameter values which define the visual characteristic represented by the point. For example, the colour of a pixel may be represented by three parameters, being for example the red, green and blue components (or hue, saturation and lightness components etc.) of the colour. In this case the VC space is a three-dimensional space in which the co-ordinates of a point correspond to the three colour components of the colour represented by that point. In this specific example, the VCC space may be referred to as ‘colour space’. In the specific examples described below, the visual characteristics consist of colour only, so the VCC space is a colour space. It is understood however that the skilled person would understand that this example could be expanded to include other visual characteristics.

The segmentation of the VCC space divides the VCC space into two or more contiguous regions or segments. In this way, the visual characteristics are divided into groups of similar visual characteristics which may be referred to as visual characteristic groups (VC groups), or, in the specific case of colour, referred to as colour groups. Such a segmentation of VCC space may be performed for example using the Watershed algorithm as described in our International patent application number PCT/GB02/05754 published as WO 03/052696, incorporated herein by reference.

In one method to segment an image, each image segment is defined in turn. In order to define an image segment, a user specifies a sample of pixels, for example by painting an area of the image, within the region of the image which is to form the image segment. The colours present in this sample of pixels form a sample of those colours within the image segment to be defined. This sample of colours is then expanded to include all colours within those colour groups containing the colours present in the original colour sample. This process produces a larger set of colours which closely approximates the complete set of colours present in the image segment to be defined. Next, a set of pixels in the image having colours belonging to the expanded set of colours are assigned to the image segment. In one case, the set of pixels may be all pixels in the image having colours belonging to the expanded set of colours. In another case, an additional condition may be imposed that the pixels of the image segment must be contiguous with the sample of pixels originally specified by the user. To complete the segmentation, the user may define further image segments by making further selections in a similar manner as described above.

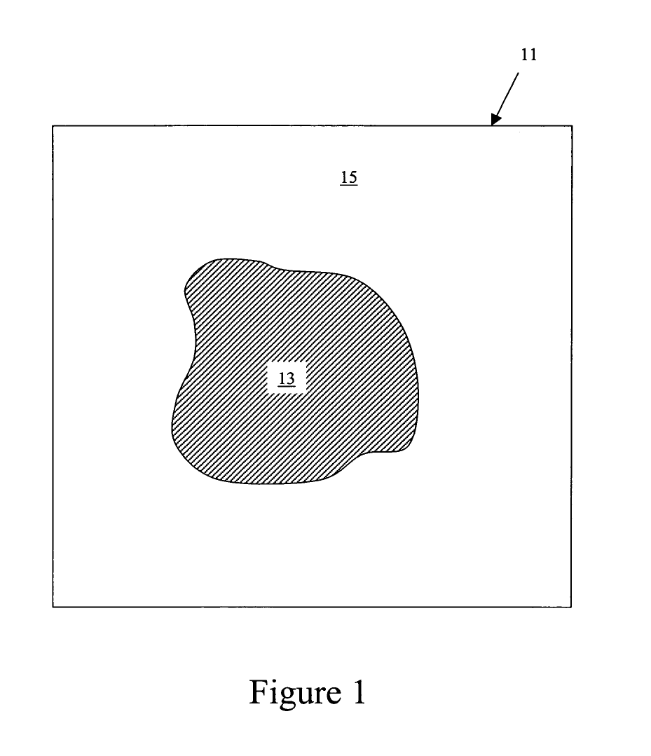

FIG. 1 shows an image 11 comprising a subject or foreground portion 13 and a background portion 15. The image 11, and the user interface to control the image processing system may be displayed on the display 3. It is understood that the present invention is not limited the case of segmentation of images into background and foreground segments. The present invention is applicable to many varied forms of image segmentation. Using the present invention, advantageously, a segmentation of the image into foreground, background and edge image segments may be made by a single user selection.

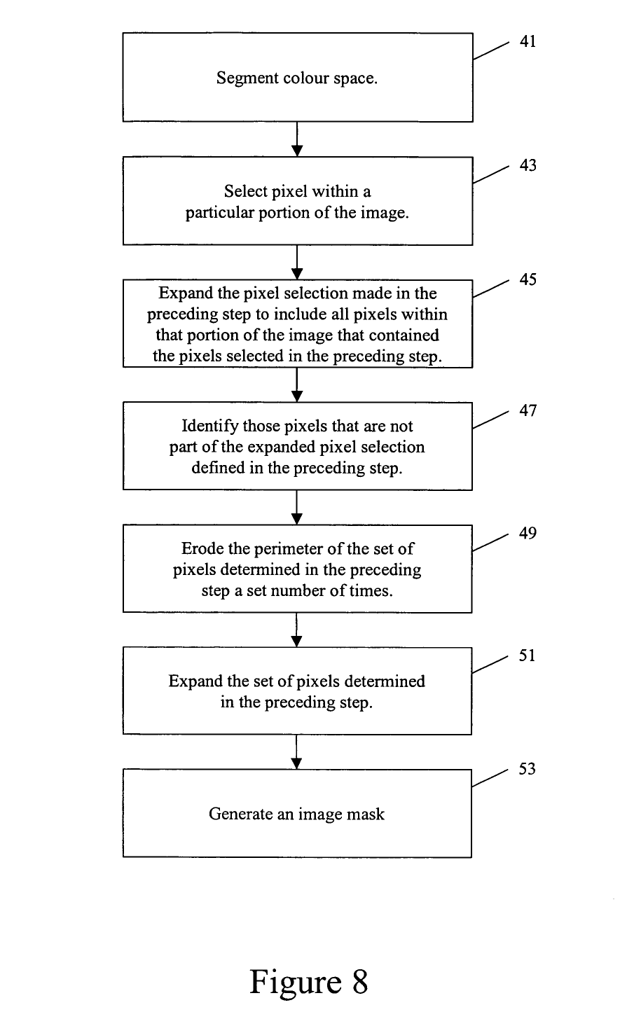

FIG. 8 is a flow chart of one exemplary method according to the invention. In a first step 41, the colour space is segmented as described above.

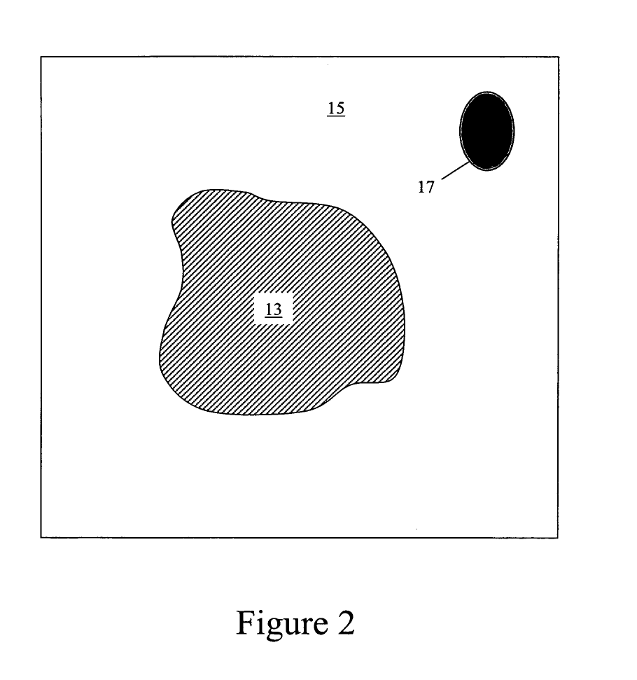

In a next step 43, the user makes a selection comprising a group of pixels in the image 11. This selection may be made using the user interface for example by the user painting a suitable area of the image 11 in either the foreground portion 13 or the background portion 15 of the image 11. FIG. 2 shows one example of a user defined pixel selection 17 made in the background portion 15 of the image 11.

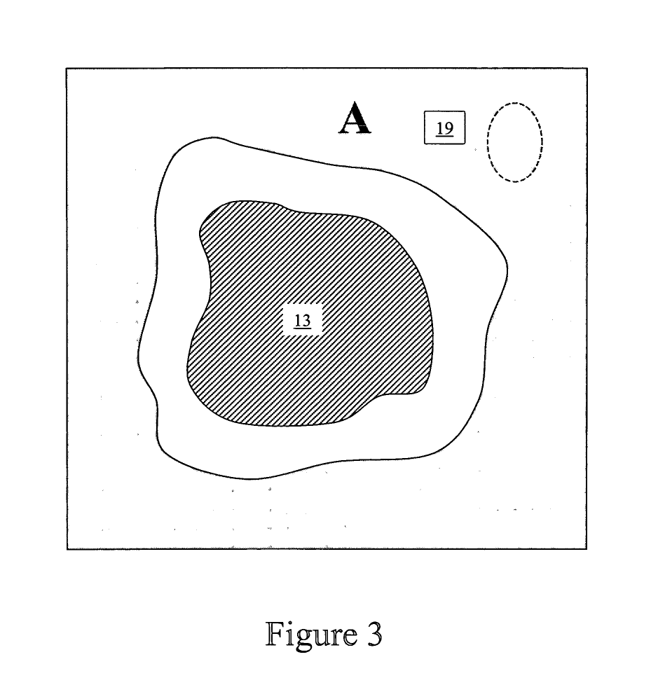

In a next step 45 the user defined pixel selection 17 is expanded so that the expanded selection contains all the pixels of whichever portion of the image (for example foreground or background) contained the pixels originally selected by the user. FIG. 3 shows the result of expanding the original user defined pixel selection 17 to obtain an expanded selection 19. The expansion may be performed using any suitable method. For example, according to a first method, the set of colours present in the original pixel selection 17 is expanded to include all colours contained in those colour groups containing colours present in the original pixel selection 17. Then, the expanded pixel selection comprises all pixels having a colour contained in the expanded colour set. According to a second method, the expanded pixel selection 19 is determined in a similar way to the first method except with the additional condition that the expanded pixel selection 19 must be a contiguous region, and contiguous with the original user defined pixel selection 17. Preferably, the original user defined pixel selection 17 should be made in whichever region of the image (i.e. foreground or background) is more uniform.

In this example, the user defined pixel selection 17 is expanded to fill the entire extent of that portion of the image (background 15 for example) in which the user defined pixel selection 17 lies by first segmenting colour space or, more generally, VC space. However, it is understood that other methods of generating a pixel selection representing an entire portion of an image from an initial selection (for example made by a user) made within that portion may be used.

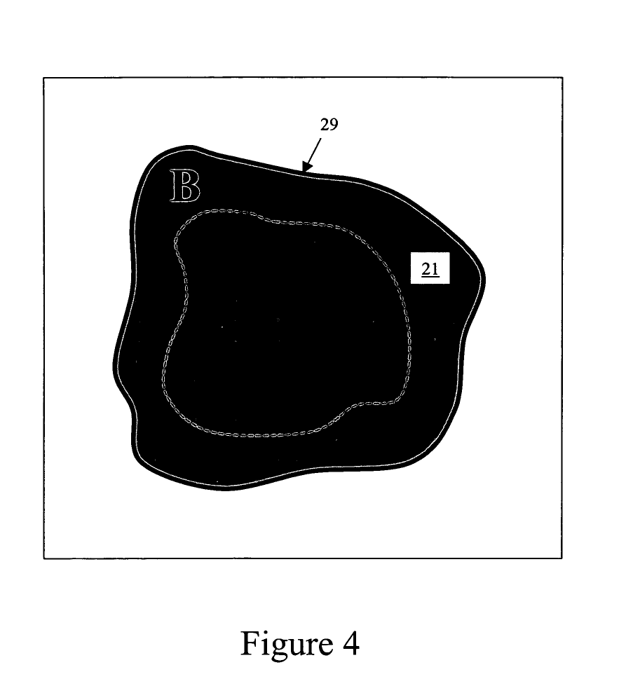

In a next step 47, those pixels in the image 11 not being part of the expanded pixel selection 19 determined in the previous step 45 are identified. Taking the pixels selected in the previous step 45 (the expanded pixel selection 19) as set A, this leaves remaining unselected pixels 21, set B, in the image 11 which, in this example, comprise foreground pixels. If foreground pixels were originally selected by the user then set B would comprise background pixels. Set B 21 may also comprise mixed pixels which are pixels whose colour contributions come both from foreground 13 and background 15 objects, for example due to translucency. The set B 21 in the present example is shown in FIG. 4.

Next, set B 21 is further subdivided in to two subsets C 25 and D 27. Set C 25 comprises those pixels representing the complementary portion of the image to that represented by the pixels in set A 19. For example, if set A 19 represents the background portion 15 of the image, set C 25 represents the foreground portion 13, and vice versa. Set D 27 comprises all pixels in the image 11 not in set A 19 or set C 25, viz the pixels which have colour contributions from both foreground 13 and background 15. The pixels in set D 27 may have blending calculations applied to determine the opacity of the mask at that pixel, and the true foreground colour at that pixel.

This subdivision may be performed in a next step 49 by taking the set B 21, and eroding its perimeter 29 (being the boundary between set A 19 and set B 21) a certain number of times, thus shrinking set B 21 and producing an eroded set B′ 23 and a boundary layer 31 between it and set A 19. The erosion may be carried out for example by removing single layers of pixels at a time from the boundary 29 of set B 21. This erosion process represents a rough method of separating the pixels of set B 21 into mixed pixels and pixels of the foreground region 13 of the image by removing mixed pixels, and possibly other pixels, from the set B 21. This leaves the boundary layer 31 between the set A 19 and the eroded set B′ 23 comprising the mixed pixels, and possibly other pixels. In this way, the eroded set B′ 23 may be subsequently expanded by a more precise method as described in greater detail below to generate a set of pixels representing more accurately the pixels of the foreground region 13 of the image 11.

Preferably, the resulting eroded set B′ 23 comprises no mixed pixels. It can be seen therefore that it is preferable that the degree of erosion is such that the thickness 31 of the eroded layer is at least as thick as the layer of the mixed pixels occurring between the foreground 13 and background 15 regions of the image 11. The number of times the boundary 29 is eroded may be specified by a parameter within the system which may be set for example either by a user or automatically by the system. The most appropriate value for this parameter may be determined by a trial-and-error process or by a user assessing the thickness of the mixed pixel boundary between the foreground 13 and background 15 regions of each image. In one embodiment, the system determines an appropriate value for the parameter by performing an analysis of the image 11 in the region of the boundary 29 between set A 19 and set B 21. For example, the system may use automated techniques to detect edges within the image 11 and to determine the thickness of the boundary layer (such as blurred edges) between objects. In this way, the system may calculate the thickness of the layer of mixed pixels surrounding the set B 21 and set the value of the parameter for eroding set B 21 accordingly.

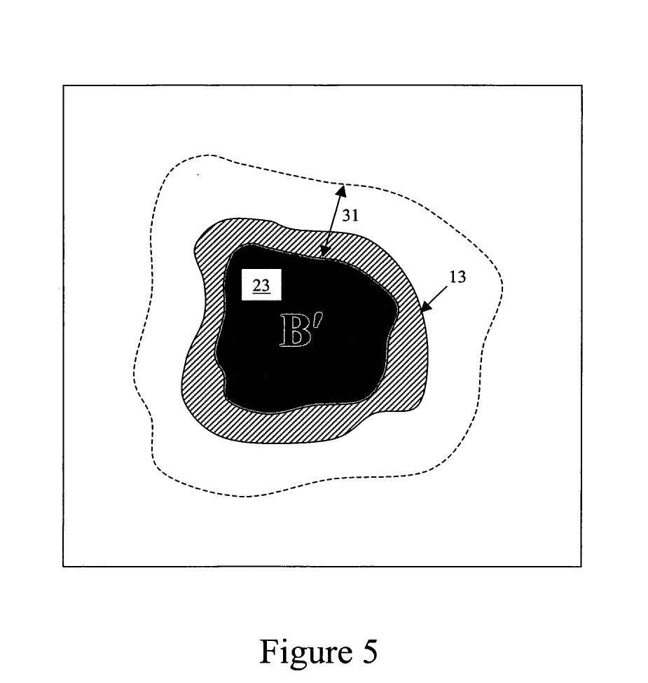

The set obtained by eroding set B 21 forms the further set B′ 23 11 shown in FIG. 5. In a next step 51, set B′ 23 is expanded out as follows. First, the set of colours present in set B′ 23 is expanded to form an expanded colour set including all colours contained in those colour groups containing colours present in set B′ 23. Then, the set B′ 23 is expanded to include all pixels that are contiguous with set B′ 23, which have colours contained in the expanded colour set, and which are not already in set A 19. The set obtained by expanding B′ 23 in the manner described forms the set C 25.

The remaining pixels, being those that are not in set A 19 or set C 25, form the set D 27 of mixed pixels.

The image 11 is thus partitioned into three sets of pixels: set A 19 (comprising pixels of the background region of the image in the above example), set C 25 (comprising foreground pixels in the above example) and set D 27 (comprising mixed pixels), after the user has made only one selection 17.

In a next step 53, the final masked image may then generated by setting the opacity level to 100% for pixels in set C 25, 0% for pixels in set A 19 in the case where set C 25 represents the foreground 13 and set A 19 represents the background 15. In the case where set C represents the background and set A represents the foreground, the percentages are swapped. In this example, the desired end result is that the background 15 is rendered fully transparent, and the foreground 13 fully opaque. The opacity level for the mixed pixels in set D 27 may be set individually to a value between 0% and 100% inclusive depending on a calculated contribution from the foreground 13 and background 15 for each mixed pixel. This may be performed using a method such as that described in our International patent application number PCT/GB2004/003336, or by any other suitable method.

Using the present invention it is possible to generate the opacity mask correctly on the basis of only one selection 17 in the image 11, for example by making a single click or paint selection of the background 15 or of the foreground 13. Edge detail and blending of partially transparent areas is preserved without the necessity for the user of making detailed selections or highlighting these areas.

The segmentation of an image may be made by making several manual selections in different portions (such as foreground, background and edge) of the image and then expanding each selection to fill the extent of whichever portion of the image the selections are made in. It can be seen that, in the method described above, an initial pixel selection is made which is then expanded. From this expanded selection, a further selection within a different portion of the image is made automatically. This further selection is then expanded to fill the extent of the different portion of the image. It can be seen that, by automatically generating pixel selections within different portions of the image to which the initial selection was made reduces the number of selections required to be made by a user.

1. A method for segmenting a digital image, the digital image comprising at least some mixed pixels whose visual characteristics are determined by a mixture of the visual characteristics of part of two or more portions of the image, the method comprising the steps of:
selecting one or more pixels within a first portion of the image to define a first pixel selection;
expanding the first pixel selection to define a second pixel selection corresponding to a first portion of the image;
defining a third pixel selection comprising those pixels in the image which are not in the second pixel selection;
eroding the boundary of the third pixel selection one or more times to define a fourth pixel selection;
expanding the fourth pixel selection to define a fifth pixel selection corresponding to a second portion of the image.

2. The method of claim 1 in which the portions of the image include a background portion and a foreground portion.

3. The method of claim 1 in which the visual characteristics includes colour or texture.

4. The method of claim 1 in which the step of selecting one or more pixels within a first portion of the image is performed by a user.

5. The method of claim 4 in which the step of selecting one or more pixels within a first portion of the image is performed by a user painting an area of the image.

6. The method of claim 1 further comprising the step of segmenting the space representing all possible combinations of visual characteristics of pixels into groups.

7. The method of claim 6 in which the step of expanding the first pixel selection to define a second pixel selection comprises the steps of:
determining the set of visual characteristics present in the first pixel selection to define a first set of visual characteristics;
expanding the first set of visual characteristics to define a second set of visual characteristics, the second set of visual characteristics including all visual characteristics contained in those groups, in the space representing all possible combinations of visual characteristics, containing visual characteristics in the first set of visual characteristics; and
determining the second pixel selection to comprise all pixels having a visual characteristic contained in the second set of visual characteristics.

8. The method of claim 1 in which the first pixel selection is expanded such that the second pixel selection is contiguous with the first pixel selection.

9. The method of claim 1 in which the step of eroding the boundary of the third pixel selection comprises the step of eroding the boundary of the third pixel selection a set number of times.

10. The method of claim 9 comprising the further step of a user visually estimating the thickness of a boundary layer in the image to determine the number of times the boundary of the third pixel selection is eroded.

11. The method of claim 9 comprising the further step of automatically analysing the image to detect edge regions in the image and the thickness of edges in the image to determine the number of times the boundary of the third pixel selection is eroded.

12. The method of claim 1 in which the step of expanding the fourth pixel selection comprises the steps of:
determining the set of visual characteristics present in the fourth pixel selection to define a third set of visual characteristics;
expanding the third set of visual characteristics to define a fourth set of visual characteristics, the fourth set of visual characteristics including all visual characteristics contained in those groups, in the space representing all possible combinations of visual characteristics, containing visual characteristics in the third set of visual characteristics; and
determining the fifth pixel selection to comprise all pixels that are contiguous with the fourth pixel selection and which have a visual characteristic contained in the fourth set of visual characteristics but which do not have a visual characteristic in the second pixel selection.

13. The method of claim 1 comprising the further step of generating an image mask.

14. The method of claim 13 in which the step of generating an image mask comprises the steps of: setting an opacity level for pixels in a first one of the pixel selections to substantially 0%; and setting an opacity level for pixels in a second one of the pixel selections to substantially 100%.

15. The method of claim 13 in which the step of generating an image mask comprises the step of setting an opacity level for pixels in a third one of the pixel selections with a range between 0% and 100%.

16. The method of claim 13 comprising the further step of generating a composite image using the image mask.

17. A system arranged to perform the method of claim 1 when suitable user input is provided.
